(19) United States
(12) Patent Application Publication
(10) Pub. No.: US 2013/0070080 A1
(43) Pub. Date: Mar. 21, 2013

(54) HIGH SPEED TENTER CHAIN INSPECTION SYSTEM

(71) Applicants: Geoffrey D. SAUCIER, North Providence, RI (US); Allan Beardwood, Coventry, RI (US)

(72) Inventors: Geoffrey D. SAUCIER, North Providence, RI (US); Allan Beardwood, Coventry, RI (US)

(73) Assignee: TORAY PLASTICS (AMERICA), INC., N. Kingstown, RI (US)

(21) Appl. No.: 13/341,603

(22) Filed: Dec. 30, 2011

Related U.S. Application Data
(60) Provisional application No. 61/535,580, filed on Sep. 16, 2011.

(51) Int. Cl. H04N 7/18

(52) U.S. Cl. 348/88; 348/E07.085

(57) ABSTRACT

A method and system to inspect high speed tenter chain components is disclosed. The novel chain inspection system include a combination of high speed-high resolution cameras, inductive proximity sensors, strobe lighting, spot cooling, and imaging software to proactively and predictively identify defective, missing, or misaligned tenter clip bearings and springs. This system significantly reduces downtime and productivity losses typically used to troubleshoot and find such damaged or missing components.

### CROSS-REFERENCE TO RELATED APPLICATION

This application claims the benefit of U.S. Provisional Application Ser. No. 61/535,580, filed Sep. 16, 2011, the entire contents of which is incorporated herein.

### FIELD OF THE INVENTION

This invention relates to a method and equipment to inspect critical components for the high speed manufacturing reliability of multi-layer biaxially oriented polymer films such as polypropylene (BOPP) and polyethylene terephthalate (BOPET) films.

### BACKGROUND OF THE INVENTION

The present invention generally relates to chains used for plastic ovens. More specifically, the present invention relates to an imaging system for the inspection and preventive maintenance of chain for plastic ovens. In the plastics industry, it is known to employ extremely large ovens to form plastic material into thin sheets or films for use in a wide array of applications such as food packaging and the like. These ovens heat the plastic material and form it into wide sheets. Two continuous loops of chains and clips, positioned and attached on opposite sides of the running plastic sheet, effectively stretch the plastic sheet to a desired thickness for later spooling, curing, slitting, etc.

The two closed loops of chain are commonly made of individual links known as “tenter” chain which is known in the art and available from companies that specialize in film orientation equipment such as Bruckner Maschinenbau GmbH, Dornier GmbH, or Parkinson Technologies, Inc. To accomplish the task of conveying and stretching the continuous sheet of running plastic, each link and clip must be extremely strong and rugged. It is not uncommon for each tenter chain link to weigh 14 lbs (ca. 6.4 kg) each. A single closed loop chain “necklace” on a given side of the tenter oven can include 260 or more eight-link segments totaling 2080 links or more. Periodically, as expected, this chain and its associated clips must undergo service and repair.

In the manufacturing process for biaxially oriented polymeric films, several processes take place for film-making. Biaxial orientation means that the polymeric film has been oriented in two directions: in the machine direction (MD) and in the transverse direction (TD). Such orientation is well-known in the art and provides the polymeric film made in such a way, useful intrinsic property improvements such as better tensile properties, transparency, gloss, gas barrier, dimensional stability, and enables thinner films for lower cost. Biaxial orientation can be done in either a sequential manner, whereby each orientation step is conducted separately (e.g. MD first, then TD is typical, although the reverse can also be done), or simultaneous, wherein both MD and TD orientation is conducted in one step in the tentering oven. The latter usually requires a specially designed chain and clip system to accommodate the changing planar dimensions of the film. Broadly speaking, the sections of a biaxial orientation line can be be described loosely as: Extrusion, whereby the polymer pellets or chips are melted and extruded (or coextruded for multilayer films) through a flat die; Casting, whereby the extruded melt is formed and quenched and solidified into a cast sheet; Machine Direction Orientation, in the case of a typical sequential orientation manufacturing line, whereby the cast sheet is oriented in the machine direction; Transverse Direction Orientation, whereby the mono-oriented sheet is oriented in the transverse direction; and Winding, wherein the biaxially oriented film is wound into rolls for further processing or as a finished product. In the case of simultaneous orientation, the machine and transverse orientation processes occur as a single step.

One of the processes for film-making is the “tentering” process which provides the transverse orientation of the film. This section of the line includes a heating oven and a system to convey the film at high speeds (in excess of 1000 fpm is possible) through the tentering process. The film is stretched and conveyed thru the oven using a chain and rail system that is made up of many different stationary and moving parts. The tenter chain is supported on three sides of a rail system using multiple bearings to keep the chain captured within the rail system. Over time, the chain system bearings wear and eventually fail if they are not maintained at regular intervals. In addition, if the polymer film breaks during transverse orientation in the tentering process, the broken film can lodge within the chain and clips and can damage or misalign the bearings due to the stresses put on the chain from such a “re-wrap.”

Once a bearing becomes misaligned or dislodged, it can cause much larger damage to the chain and rail system if it gets jammed into other chain links during operation. The tenter chain clip heads also have two springs that are used to keep the film captured as it is stretched through the oven. If the springs become dislodged, they too can get jammed into the chain system and damage the chain or simply cause more film breaks due to a lack of film edge capture in the clips. This creates undesirable losses in productivity. It is thought that the use of high-speed camera technologies could be used to identify damaged clips and bearings and thus proactively identify and repair such damaged parts in a timely fashion before further damage can be incurred.

However, the operating environment around a tenter oven process is very challenging due to the high ambient air temperatures encountered. In order to stretch the polymeric film transversely, the polymeric cast film or uniaxially-stretched film must be heated to near its melting point. In the case for polypropylene (PP) film-making, this melting point is about 160° C. (320° F.); for polyethylene terephthalate (PET), its melting point is about 260° C. (500° F.) typically. Other polymers such as polylactic acid (PLA), nylon (polyamide), polystyrene (PS), also will have melting points at or above 130° C. (266° F.) respectively. These tenter oven temperatures are achieved typically through gas-fired hot air blowers; consequently, at the inlet and outlet of the tenter oven, ambient air temperature is typically 54° C. (130° F.) or higher, depending on the proximity to the tenter oven entrance or exit. In addition, the metal chain and clips are often at the same temperature as the oven interior −130° C. (266° F.)—and due to the high speed at which they travel, do not cool off appreciably as they exit and enter the tenter oven. Thus, the use of high-speed cameras alone to identify defective chain clips is insufficient as they are not designed for extreme temperatures (typical operating temperature range for such cameras is about 46° C. (115° F.)) and will fail in such environments.

Early detection of issues with the tenter chain system components is critical for avoiding major chain system failures and extended production downtime. Prior to this invention, maintenance and production personnel had no predictive means for preventing major system chain failures other than to experience a sudden increase in tenter oven film breaks. Finding clip reliability problems within the chain is a very time-consuming process that requires personnel to manually inspect each clip to locate the failure and eventually fix the defective clip. This can take hours of maintenance downtime versus having the ability to know exactly where the issue lies within the chain system and being able to shut-down the line opportunistically in a controlled manner to fix the defective clips.

Adapting robust, long-life, high-speed, real-time vision-imaging technology to the tenter chain system will help identify issues early-on in the failure process so that they can be fixed in a timely, preventative manner before the conditions worsen and cause extended unplanned downtime and lost productivity. Inspecting tenter chain links with high speed vision system technologies allow end-users to continuously monitor and confirm chain system integrity during production and provide users with instantaneous feedback of any issues that surface during operation. Early detection and specific awareness of chain issues are critical information needed to make informed decisions around shutting down production equipment before a chain failure occurs and causes extended, unplanned production downtime.

Cognex Corporation product literature (“Cognex 2010 Product Guide In-Sight Vision Systems”) describes the use of their camera acquisition system and imaging software for inspecting product goods in manufacturing plants such as pharmaceuticals, bottles, containers, barcodes, automotive parts, and other product parts. However, the Cognex system does not recommend nor suggest their cameras in combination with induction proximity sensors, spot cooling, and strobe lights for identifying and predictive forecasting of failing clip bearings and springs in high-speed tenter chains and clips for biaxially oriented film tenter lines. The use of the Cognex vision system alone is not sufficient for adequate identification of defective clips and bearings, nor is it robust enough to tolerate the extreme environmental conditions during normal film-manufacturing.

### SUMMARY OF THE INVENTION

The above issues of identifying defective components, predicting failure, and implementing preventative maintenance, of chain and clip components of high-speed biaxial orientation of polymeric films in a tentering process are addressed. The inventors have found solutions whereby the use of high-speed vision cameras, imaging software running on a processor, LED strobe lighting, induction proximity sensors, spot cooling, and alarms enable continuous inspection of each individual clip and its associated bearings and springs such that timely identification of defective parts, predictive failure of parts, and timely preventive replacement/repair of parts can be realized with a consequent reduction of downtime and improvement in productivity. The inspection system is also designed such that it can withstand the harsh environment around the tenter oven in which it must operate.

In one embodiment, the tenter clip inspection system for biaxially oriented polymer film manufacturing includes at least one high-speed, high-resolution camera, at least one LED strobe light, at least one inductive proximity sensor, at least one image analysis software, and at least one air conditioning drop or unit that maintains the camera temperature at 54° C. (130° F.) or less during operation. The camera is installed in such a way that the relevant bearings or springs of interest are captured within its field of view. Such bearings may be the guide bearings of the clip or the vertical bearings which anchor the clip to the support rail. The camera and imaging software system measures the relative position—distance and angle—of the target bearing to the supporting beam or rail. Specific distances and angles may be set as desired pending the configuration of the bearings and support rails for the chains. Tolerances and specifications may be set around these set distances and angles to determine if the inspected bearing is conforming within desired design parameters or not; if not, then said bearing can be identified to the user as non-conforming and requiring inspection and repair.

In addition, clip springs can also be inspected by using contrast ratio to identify whether said springs are present or missing. The camera and imaging system software can be configured to measure contrast levels within the portions of the clip that contain the springs. A high contrast level—which indicates the presence of the spring from the surrounding clip body—indicates a conforming clip and spring assembly. A low contrast level—which indicates a missing spring from the clip body—indicates a non-conforming clip and spring assembly. The imaging software can then flag this clip to the user as non-conforming for possible inspection and repair.

Another component to the overall system is the use of inductive proximity sensors to identify and signal the presence of a clip for inspection to the camera and imaging system. At least one inductive proximity sensor is set in such a way that the sensor's alternating electro-magnetic sensing field is within the path of an oncoming clip. As the clip enters the sensing field, eddy currents are generated within the target clip and triggers an output signal from the sensor. This signal in turn, triggers the image acquisition software of the camera to capture that clip image for analysis and inspection.

Adequate lighting is used for this system to operate properly, consistently, and accurately. High speed strobe lights are desired for use as they can be synchronized with the camera image acquisition software. Thus, the appropriate clip and portions of the clip (i.e. bearings and springs) can be accurately imaged and analyzed.

Yet another component of the inventive system is the use of portable air conditioning units or “spot coolers” to provide adequate cooling and a suitable ambient operating environment for the camera and strobe light systems. Without such “spot cooling”, the operating life of the camera and lighting systems may be severely curtailed. Temperature monitoring systems are also used to measure the camera temperatures such that if ambient temperatures rise above the camera's safe operating parameters, the camera can be shut-down until cooled to safe conditions.

It is therefore the object of this invention to provide a method to improve the predictive maintenance of tenter chain clip components that are used in the film orientation manufacturing process. This invention can significantly reduce the downtime or lost productivity incurred by manual inspection of tenter chain clips to identify defective components.

One embodiment of a tenter clip inspection system for a biaxially oriented polymer film manufacturing process includes a high-speed and high-resolution camera, an inductive proximity sensor configured to identify a presence of a clip for inspection by the camera, a processor configured to determine a pass/fail result for each tenter clip inspected by the camera, and at least one cooler configured to maintain a temperature of the camera at 54° C. or lower during operation.

The inspection system may further include a strobe lighting system configured to illuminate the tenter clip as it is inspected by the resolution camera. The strobe lighting system may include LED lighting. The guide bearings, the vertical bearings, and/or the springs of each tenter clip may be inspected by the camera. A clip spring presence may be identified utilizing a contrast ratio between the spring and its surroundings.

In some embodiments, the determined pass/fail result for each tenter clip may be based on guide bearings of each tenter clip being within a certain distance between a top of the bearing to a surface of a main supporting rail or beam. In some embodiments, the pass/fail result for each tenter clip may be based on guide bearings of each tenter clip being within a certain angle respective to a surface of a main supporting rail or beam. An embodiment of a method of inspecting tenter clips during a biaxially oriented polymer film manufacturing process may include identifying a presence of a clip for inspection using an inductive proximity sensor, inspecting the identified clip using a high-speed and high-resolution camera, determining a pass/fail result for each tenter clip inspected by the camera using a processor, and cooling the camera to maintain a temperature of camera at 54° C. or lower during operation.

Additional advantages of this invention will become readily apparent to those skilled in the art from the following detailed description, wherein only the preferred embodiments of this invention is shown and described, simply by way of illustration of the best mode contemplated for carrying out this invention. As will be realized, this invention is capable of other and different embodiments, and its details are capable of modifications in various obvious respects, all without departing from this invention. Accordingly, the examples and description are to be regarded as illustrative in nature and not as restrictive.

### BRIEF DESCRIPTION OF THE DRAWINGS

The novel features which are characteristic of the present invention are set forth in the appended claims and examples. However, the invention's preferred embodiments, together with further objects and attendant advantages, will be best understood by reference to the following detailed description taken in connection with the accompanying figures in which:

FIG. 1A is a cross-sectional view schematic of the clip camera inspection system, chain and clip components (including bearings and springs), supporting rail for the chain, and supporting framework for the inspection system according to an embodiment of the invention.

FIG. 1B is a picture of one of the cameras, associated strobe light, and supporting framework, mounted upon the chain rail system for inspection of the clip springs according to an embodiment of the invention.

FIG. 1C is a picture of one of the cameras, associated strobe lights, and supporting framework, mounted upon the chain rail system for inspection of the guide bearings according to an embodiment of the invention.

FIG. 1D are side and top pictures of an individual clip and link of the tenter chain, indicating the vertical bearing and 4 horizontal guide bearings numbered 1 to 4 for inspection by the camera according to an embodiment of the invention. Bearings 1 and 2 are upper guide bearings; bearings 3 and 4 are lower guide bearings.

FIG. 1E is a cross-sectional sketch of the clip and link assembly upon the chain rail and support framework (not to scale) according to an embodiment of the invention.

FIG. 1F is a picture of and individual clip and link marked with an identification number according to an embodiment of the invention.

FIG. 2A is a screen-shot of the image capture of a clip by the inventive system, showing the clip's guide bearings positioned on the supporting chain rail and rail framework according to an embodiment of the invention.

FIG. 2B is a picture of the chain rail framework with cut-outs to enable the camera to image the bearings and springs according to an embodiment of the invention.

FIG. 2C is a picture of the chain rail framework with cut-outs to enable to the camera to image the bearings according to an embodiment of the invention.

FIG. 3A is a screen-shot of the image capture and software analysis measurement of the reference position of the bearings for pass/fail tolerances according to an embodiment of the invention.

FIG. 3B is a screen-shot of the image capture and software analysis of the bearing positions and interface with the software according to an embodiment of the invention.

FIG. 4 is a screen-shot of the image capture and software analysis of the clip springs' presence according to an embodiment of the invention.

FIG. 5A is a picture showing a portable air conditioning unit and spot cooling ducts to the camera system to control the camera's environmental temperature according to an embodiment of the invention.

FIG. 5B is a picture showing a portable air conditioning unit and spot cooling ducts to the camera system to control the camera's environmental temperature according to an embodiment of the invention.

### DETAILED DESCRIPTION OF THE INVENTION

The present invention provides a method to monitor and inspect tenter oven clip and chain components such as bearings and springs in real-time and to identify when said components are missing, damaged, or misaligned. The method is directed towards a novel and unique system that provides said real-time inspection, analytical software capabilities, and robustness in harsh, high ambient temperature conditions, using a combination of digital high-speed cameras, analytical imaging software, induction proximity sensors, and spot cooling supply to protect said camera systems.

Described are methods and equipment to inspect critical components for the high speed manufacturing reliability of multi-layer biaxially oriented and/or “tentered” (transverse oriented) polymer films such as polypropylene (BOPP) and polyethylene terephthalate (BOPET) films. The methods and equipment can also be applied to other biaxially oriented film manufacturing applications such as that for nylon or polyamide films, polystyrene films, polyethylene films and other polymeric films which utilize tentering technologies. The methods and equipment could also be contemplated for use in the manufacturing of other polymeric substrates or articles that utilize tentering technologies such as that for making plastic snow, poultry, gardening, or construction fencing or netting.

Specifically, the chain and clip components for the transverse orientation process (aka “tentering”) include multiple bearings and springs that can be prone to damage and misalignment which can then result in film breaks and productivity losses. A high speed camera imaging system has been devised which can identify individual chain sections (links), clips, and components of said chain links and clips, for potential failure and allow predictive and preventative maintenance of such components before unacceptable productivity losses or catastrophic failure occurs.

The clip inspection system includes at least one high speed, high resolution camera. Suitable cameras of this type are those digital cameras as manufactured and supplied by Cognex Corporation. In particular, Cognex's In-Sight® model IS5600-00 camera is preferred, having a 20× speed rating, 60 fps acquisition, and 640×480 resolution. Preferably, the high speed camera has a frame acquisition rate of at least 20 fps, more preferably, at least 40 fps, more preferably, at least 50 fps. Preferably, the camera has a resolution of at least 640×480. A 16 mm lens for the camera is suitable for the camera.

The clip inspection system also included a lighting system to adequately illuminate the area in which the camera is imaging. Preferred was the use of strobe lighting, set to a frequency to match the speed of the passing clips such that each individual clip is captured or “frozen” by the strobe. Particularly preferred are LED high speed overdrive strobe light rings to illuminate the desired inspection location for fast response, bright lighting, durability, long-life, and lower energy consumption.

An induction proximity sensor for each inspection location connected to the camera and strobe lighting was also included in the system. The inductive proximity sensor emitted an alternating electro-magnetic sensing field. When a metal target—such as a clip—entered the sensing field, eddy currents were induced in the target, reducing the signal amplitude and triggering a change of stated at the sensor output. The inductive proximity sensor produced a square wave pulse when a metal object such as a clip traversed in front of it. The inductive proximity sensor is placed in such a way that the passing clip target generates one pulse per clip. This pulse then triggered the strobe light and the image acquisition of the target clip by the Cognex camera system; the induction sensor also supported independent clip counting functions within each camera's software and data processor. Suitable inductive proximity sensors can be obtained from Baluff, Inc., model number BES 516-114-SA1-15 and are designed for high temperature applications. Other advantages of inductive proximity sensors include insensitivity to heat, water, oil, dirt, non-metallic particles, target color, target surface finish, and the ability to withstand high shock and vibration. Some or all of these harsh conditions can be found in proximity to tentering oven environment.

The “brains” of the clip inspection system utilized Cognex's VisionView® and Explorer® software running on a computer including a processor. This software provided image acquisition and analysis and enabled determination and setting of “pass/fail” criteria for the clip's bearings and springs. The software also enabled a user interface to easily manipulate such criteria and also triggered alarms to identify those clips which failed to meet such “passing” specifications. Control panels and monitors compatible with the Cognex software were also installed for user interfacing.

Yet another component is the use of portable air conditioning units or air conditioning “drops” from a central air conditioning unit to provide spot or area cooling to the cameras. As the camera is sensitive to heat—and the environment around a tenter oven is a relatively high heat environment due to the need to orient the polymer materials—the use of such spot cooling is essential to prolong the life and robustness of these high speed, high resolution digital cameras. Camera reliability is essential to the proper functioning of the inventive clip inspection system. Thus, it is essential to maintain the camera units within its safe temperature operating window. The spot cooling maintained camera operating temperature at 40° C. (105° F.) or lower. If portable air conditioning units are used, suitable models are those manufactured by Denso Sales California, Inc. MovinCool® Classic 40 or Classic Plus 14.

This invention will be better understood with reference to the following examples, which are intended to illustrate specific embodiments within the overall scope of the invention.

### EXAMPLE 1

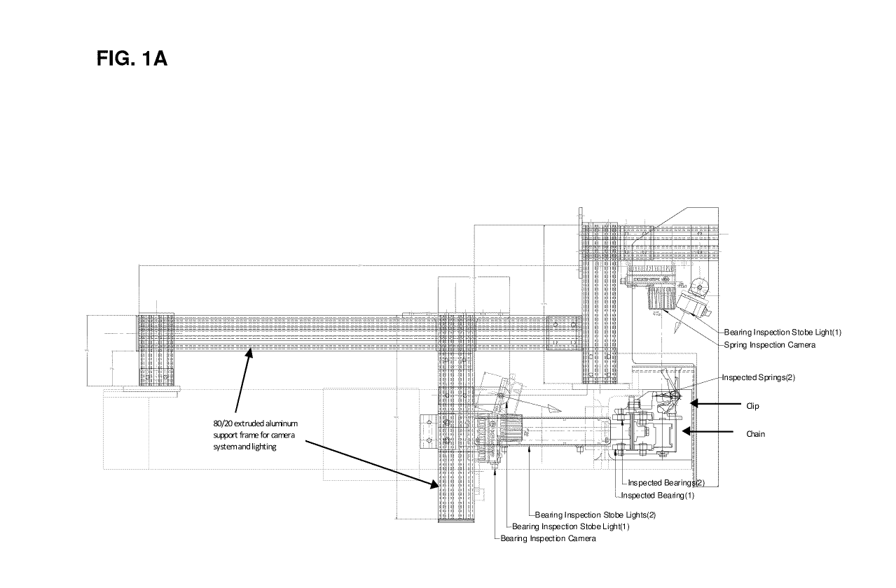

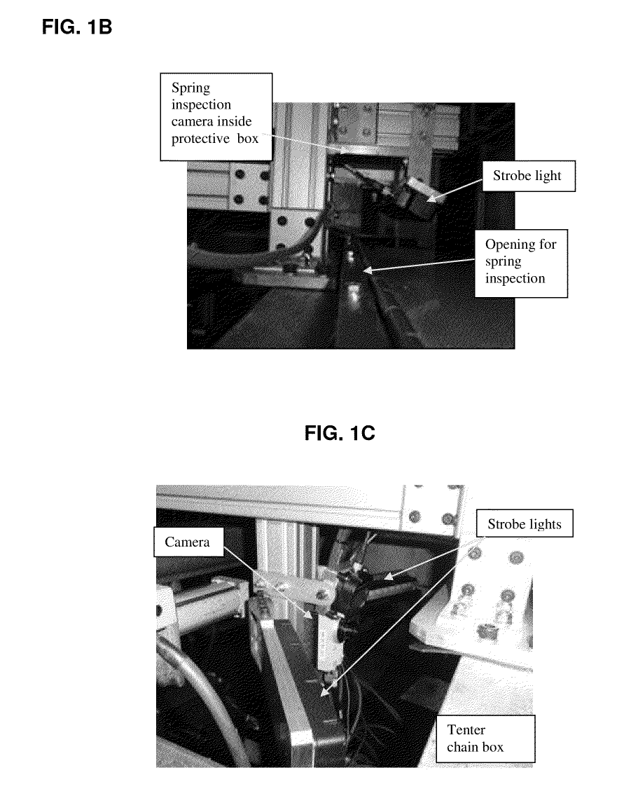

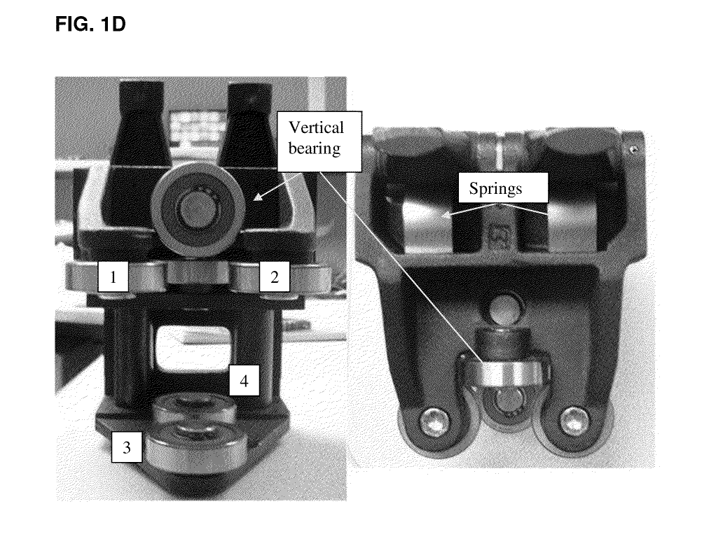

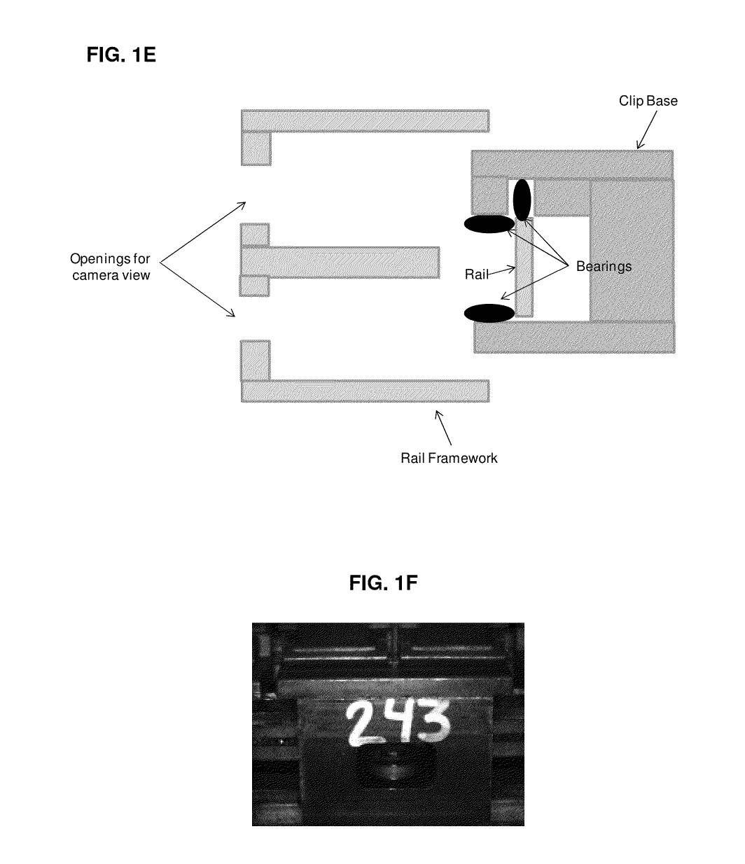

A multi-layer 6-meter wide BOPP sequential orientation line including a transverse orientation oven with two chains (“necklaces”) with clips for capturing the polymer film on each side edge was modified with the high-speed camera system. Each chain included about 1000 clips; each clip included 5 bearings (FIG. 1D). (The number of clips and bearings was not a limitation; depending on the size of the biaxial orientation line, the length of the tenter oven, the design and size of the clips, the number and location of clips, bearings, springs, and other components could differ. The invention could also be used for chain and clip designs that do not include bearings, e.g. slider chain designs) Each clip was also marked with a unique identifying number so that when a defective clip was spotted, the chain could be indexed to that specific clip for inspection and repair (FIG. 1F).

FIG. 1E shows a sketch that indicates the relative position of the clip base and bearings (horizontal guide bearings and vertical bearing) on the chain rail and framework system. Also indicated in the sketch are “cut-outs” in the tenter chain box/framework to enable the camera system to view the respective bearings for image capture.

The clip inspection process utilized a total of six high speed cameras to inspect every clip for missing bearings, misaligned bearings (four per chain), and missing springs (two per chain). (The number of cameras used was not a limitation; additional cameras could be used as desired to inspect other parts or aspects of the chain and clip assembly.) The bearing and spring inspections were completed on both sides of the tenter chain system using four separate cameras; two cameras monitored the clips for missing or misaligned bearings while a third camera monitored for missing springs. Every single clip was inspected in real-time for a pass/fail result (as established by specifications developed for the image analysis software) and every clip designated as “failing” inspection (i.e. not meeting the specifications for alignment tolerance or position or presence) was stored by the system to allow operators to review each and every specific clip issue. All clip inspections were completed using gray-scale images (bitmap images) acquired by the camera in conjunction with pixel-based measurement tools that executed inside the camera.

“Pass/Fail” criteria for each inspection of each clip was based on hard-coded settings within the camera and user-defined parameters available through the touch-screen of the Cognex software and associated monitors and control panels. Once a camera identified an issue with a specific clip, the system annunciated the failed inspection condition on an operator interface panel using audible and visual alarms and also allowed operators to review the failed inspection to see what specific inspection tolerance or specification failed.

The clip inspection equipment was mounted on both tenter entrance returns using 80/20 extruded aluminum as shown in FIGS. 1A-C. Both setups were identical and included high speed inspection cameras, high speed overdrive strobes, spot cooling, and an inductive proximity sensor. Both cameras were positioned approximately 12 inches (30.5 cm) from the inspected parts along with high speed overdrive strobe lights that were required to synchronize part lighting with camera image acquisition. The cameras and strobes were triggered by an inductive proximity sensor (1 per side) which in turn, was triggered by every passing clip. The inductive proximity sensors emitted an alternating electro-magnetic sensing field. When a metal target (such as a clip) entered the sensing field, eddy currents were induced in the target, reducing the signal amplitude and triggering a change of state at the sensor output. The inductive proximity sensor produced a square wave pulse when a metal object such as a clip traversed in front of it. The proximity sensor was positioned directly above the clips' (within 5 mm) upper vertical bearing as this provided a suitable target for producing one pulse per clip. This pulse then triggered the image acquisition by the Cognex camera system; the induction sensor also supported independent clip counting functions within each camera.

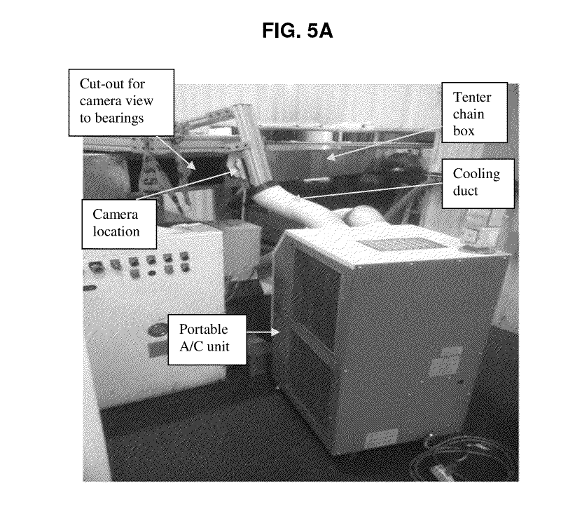

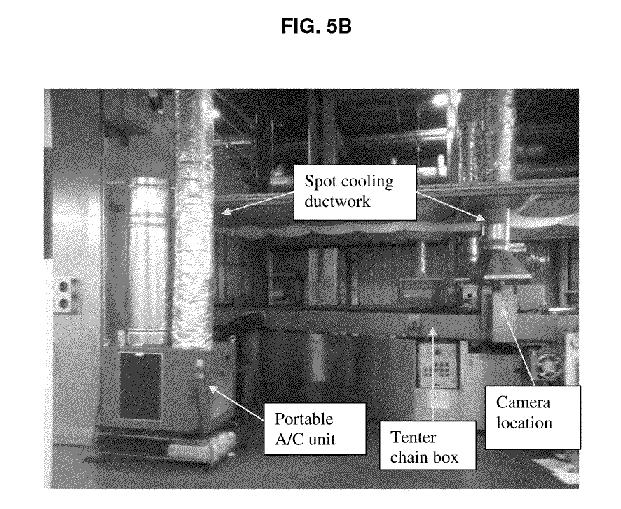

Another key component for the inventive clip inspection system was the use of portable air-conditioning units to provide spot cooling for the cameras. This was essential in order to keep the camera units within its safe temperature operating window. As mentioned previously, the ambient air temperature around the tenter oven area where the cameras were best located are typically 54° C. (130° F.) or higher, well above the maximum operating temperature of the cameras themselves at 46° C. (115° F.). Thus, to ensure long-life and robustness of the system, spot cooling was essential. Automated temperature controls were designed/installed to protect the camera and strobe lighting system. Air conditioning drops were installed to supply cool air to all camera locations and temperature monitoring modules put into place to shut off power to the cameras if the environmental temperature rose above 40° C. (105° F.). Cooling air was supplied by an air-conditioning (A/C) unit from the main manufacturing plant and/or by a portable cooling unit to ensure redundancy. More specifically, if the main A/C unit failed, a temperature monitoring circuit would alarm to alert operators that the primary cooling air supply was down and to keep the cameras running with a backup unit to supply cool air to protect them from overheating. FIGS. 5A and 5B illustrate embodiments for supplying cooling air to the cameras via portable air conditioning units and appropriate ductwork.

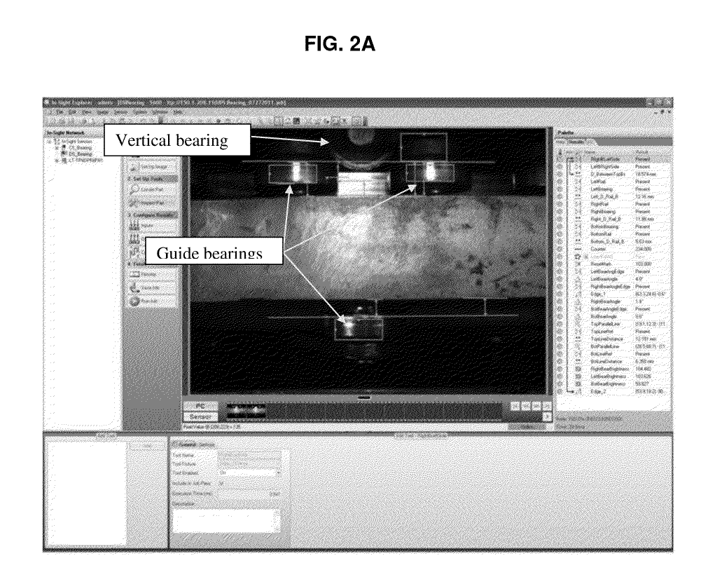

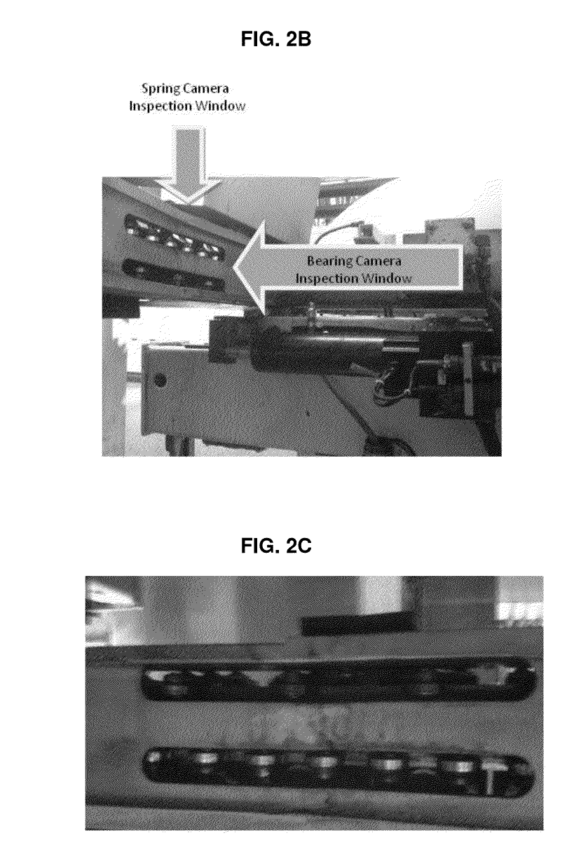

The bearing inspection camera confirmed the presence and alignment of four bearings located on each clip. Each clip had two upper guide bearings and two lower guide bearings plus a vertical bearing as shown in FIG. 1D. FIG. 2 showed that the bearing inspection camera viewed 3 of the 4 guide bearings (an additional camera could be positioned on the opposite side of the chain/clip to inspect the hidden guide bearing #4) and the vertical bearing. The camera inspected each bearing through a slot that was machined into the back side of the tenter chain framework I-beam. The parts were illuminated with high speed overdrive strobe lights that were synchronized with the camera acquisition using an inductive proximity sensor located above the vertical bearing.

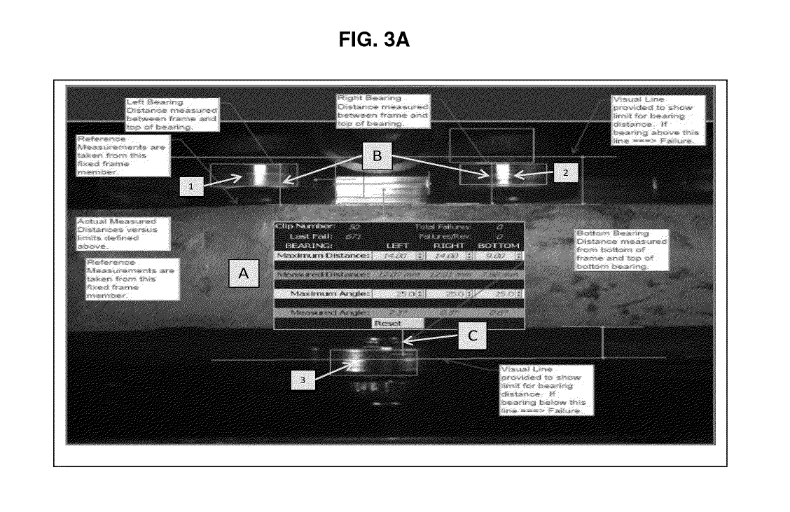

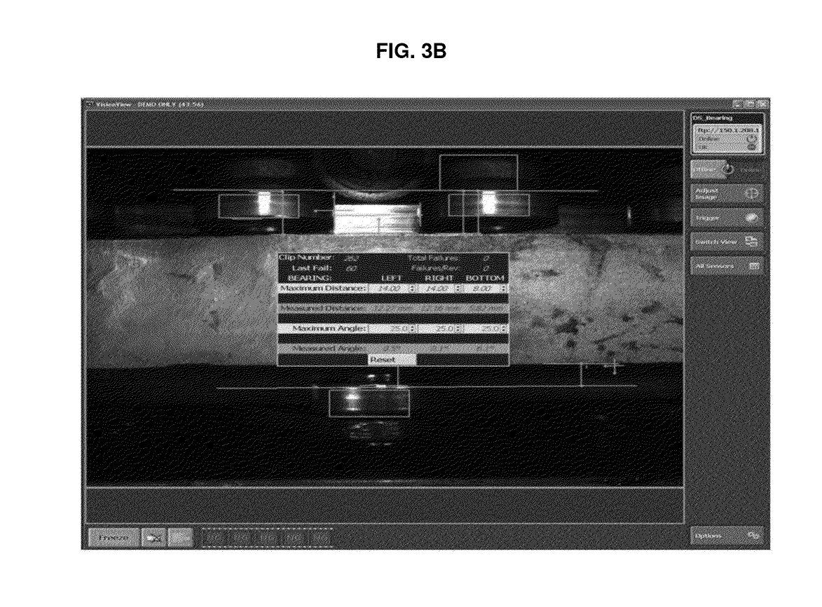

The bearing inspection process utilized multiple inspection tools, as shown under the “Palette” section on the right of FIG. 2, to confirm both presence and position of the inspected guide bearings. All three bearing distances were measured from fixed positions on the main supporting beam (“rail”) and the results were compared with specific minimum and maximum (“min/max”) values to determine pass/fail results. Measurements that fell within the min/max range were passed and highlighted in green, while measurements outside the min/max range were failed and highlighted in red. FIG. 3A portrayed the measurement parameters and reference points for determining defective bearings as an example. The relative position of the respective bearing was measured with reference to the supporting beam “A”. Thus, for the upper left and right bearings “1” and “2”, the important measurement to monitor was the distance “B” from the top of the respective bearing to the top of the supporting beam “A”. In this example, the maximum distance tolerance was 14.0 mm for bearings “1” and “2” (of course, depending on a particular chain and clip design, these tolerances and specifications could be modified to fit that particular clip design). If the respective bearing position stayed within this maximum distance, the bearing “passed” the inspection; if the bearing position exceeded this maximum distance, the bearing “failed” the inspection. As shown in FIG. 3A, the actual measurement for bearings “1” and “2” were 12.07 and 12.01 mm, respectively; thus, these bearings passed inspection.

Similarly, for the bottom bearing “3”, the bearing's position was monitored in relation to the supporting beam “A”: the important measurement was the distance “C” between the top of bearing “3” and the bottom of the supporting beam “A”. In this example, the maximum distance tolerance was established as 9.0 mm. If the respective bearing position stayed within this maximum distance, the bearing “passed” the inspection; if the bearing position exceeded this maximum distance, the bearing “failed” the inspection. As shown in FIG. 3A, the actual measurement for bearing “3” was 7.60 mm; thus, this bearing passed inspection.

In addition to the distance between the bearing and the supporting rail, the angle of the bearing was also monitored. Again, the angle of each bearing itself was measured with respect to its relation to the main supporting beam “A” as the horizontal plane. If the respective bearing position stayed within this maximum angle, the bearing “passed” the inspection; if the bearing position exceeded this maximum angle, the bearing “failed” the inspection. The maximum angle specification set for each of the bearings “1”, “2”, and “3” in this example was 25°. As shown in FIG. 3A, the angles for the respective bearings were measured as 7.3°, 0.3°, and 0.6°, respectively; thus, all three bearings passed inspection.

For missing bearings, the camera inspection software was also configured to fix the bearing image within its field of view and then measure contrast levels between the bearing and its surroundings. High levels of contrast indicated the presence of the bearing (“Pass” inspection), while lower levels indicated the bearing was missing (“Fail” inspection). Thus, the presence or absence of three of the four guide bearings and the vertical bearing could be monitored.

Operators of the system could also view the system results using the custom view screen shown below in FIG. 3B. In this view, operators could quickly see how many failures had occurred with each revolution of the chain or the total number of failures encountered since the system was last reset. Real-time distance measurements could also be viewed for all three bearings along with the specific clip number being inspected. The system also identified the last failed inspection clip number to aid operators in knowing which clip had issues.

Another significant benefit of this system was its ability to store the failed images into a “film strip.” Storing the failed images within the film strip allowed operators to replay the image directly through the camera job so that they could observe what was wrong with the part. Knowing the extent of the inspection failure allowed maintenance and production personnel to make an informed decision around shutting down the film line. Prior to this capability, production personnel would continue to run until film breaks occurred at high enough levels to warrant looking for possible causes or until the chain failed catastrophically.

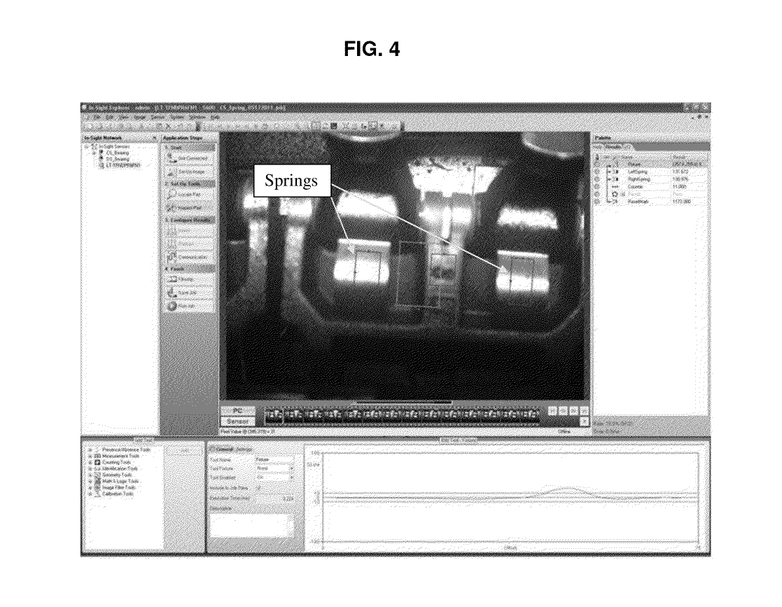

The spring inspection camera confirmed the presence of two springs located in the top left and right cavities of each clip head as shown in FIG. 4 below. The camera was mounted directly above the tenter chain guard covers in the same relative position as the bearing cameras depicted in FIGS. 1A and 1B. Spring inspection was realized by cutting notches into the existing chain guards with the remaining pinch points guarded by secondary safety guards. The spring inspection camera acquired images using the same inductive proximity sensor used to capture bearing images. Part illumination was achieved with a single 12″ LED strobe light that was identical to those used within the bearing inspection setup.

The camera inspection software was configured to fix the clip top within its field of view and then measure contrast levels within the left and right clip cavities. High levels of contrast indicated the presence of a spring within the cavity (“Pass” inspection) while lower levels indicated the spring was missing (“Fail” inspection). Once the camera encountered a failed inspection, it annunciated the failure on the system control panel using audible and visual alarm indicators and saved a copy of the image within the camera film strip, along with the specific clip number, so it could be reviewed by the operators. Knowing which specific clip had missing springs allowed production and maintenance to quickly index the chain to the trouble area so it could be fixed in a timely manner. Prior to this inspection system, the tenter chain was manually inspected for missing springs by ceasing film production, slowing the chain, and manually inspecting both chains using flashlights to find the issue. This process was very time consuming and inefficient.

In operation, the inventive clip inspection system successfully identified defective or near-failing clip bearings and/or missing springs in real-time and enabled rapid identification and location of the failing clip. Such identification of failing clips was accomplished within minutes.

### COMPARATIVE EXAMPLE 1

The multi-layer BOPP line of Example 1 was used except without the high-speed clip inspection system installed. During a maintenance shutdown, 9 bearings were found loose on the production line floor, indicating that several clips had lost their bearings during running. Maintenance and production personnel required several hours to manually inspect the chains to identify the clips with the missing bearings. In order to ensure that the specific clips were identified, maintenance personnel had to remove a total of 246 clips (roughly 25% of the clips on one chain necklace). This incurred a great deal of time and cost to identify the defective clips. The use of a real-time high-speed clip inspection system could have quickly identified and located the exact defective clips.

The above examples should be considered as illustrative of the invention and not restrictive. The invention can be applied to other high-speed biaxial orientation of other polymeric films such as polyethylene terephthalate (OPET), high density polyethylene (OHDPE), polystyrene (OPS), nylon (BON), polylactic acid (OPLA), or other polymer types and systems suitable for high speed sequential or simultaneous biaxial orientation manufacturing processes. Indeed, the invention can be applied to any manufacturing process that involves a tentering process using a chain/clip system to improve preventive and predictive maintenance of said clips and reduce productivity losses.

### Test Methods

The various properties in the above examples were measured by the following methods:

Guide bearing Pass/Fail criteria: 1) Measurement of the distance between the top of the respective guide bearing of the inspected clip to the nearest horizontal surface of the main supporting beam or rail which supported the clip. The typical “Pass” distance was determined by measuring a suitable number of conforming bearings and establishing this value as a maximum specification; 2) Measurement of the angle of the bearing's horizontal position relative to the horizontal surface of the main supporting beam. The typical “Pass” angle was determined by measuring a suitable number of conforming bearings and establishing this value as a maximum specification. If the respective bearing did not meet the maximum specification for the distance or angle (or both) to the supporting beam's reference point, the respective bearing was considered to be a “Fail” and would be identified to the user as a clip recommended for repair.

Clip spring Pass/Fail criteria: Measurement of the contrast ratio between the respective spring and the cavity adjacent to it on the clip being inspected. The typical “Pass” contrast ratio was determined by measuring a suitable number of conforming springs and establishing this value as a specification to indicate the spring's presence. If the respective clip's springs contrast ratio did not meet this specification, the respective clip was considered to be a “Fail” and would be identified to the user as a clip recommended for repair.

This application discloses several numerical ranges in the text and figures. The numerical ranges disclosed inherently support any range or value within the disclosed numerical ranges even though a precise range limitation is not stated verbatim in the specification because this invention can be practiced throughout the disclosed numerical ranges.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein. Finally, the entire disclosure of the patents and publications referred in this application are hereby incorporated herein by reference.

We claim:

1. A tenter clip inspection system for a biaxially oriented polymer film manufacturing process comprising:
a. a high-speed and high-resolution camera;
b. an inductive proximity sensor configured to identify a presence of a clip for inspection by the camera;
c. a processor configured to determine a pass/fail result for each tenter clip inspected by the camera; and
d. at least one cooler configured to maintain a temperature of the camera at 54° C. or lower during operation.

2. The inspection system of claim 1, further comprising a strobe lighting system configured to illuminate the tenter clip as it is inspected by the resolution camera.

3. The inspection system of claim 2, wherein the strobe lighting system comprises LED lighting.

4. The inspection system of claim 1, wherein guide bearings of each tenter clip are inspected by the camera.

5. The inspection system of claim 1, wherein the vertical bearings of each tenter clip are inspected by the camera.

6. The inspection system of claim 1, wherein the springs of each tenter clip are inspected by the camera.

7. The inspection system of claim 1, wherein the determined pass/fail result for each tenter clip is based on guide bearings of each tenter clip being within a certain distance between a top of the bearing to a surface of a main supporting rail or beam.

8. The inspection system of claim 1, wherein the pass/fail result for each tenter clip is based on guide bearings of each tenter clip being within a certain angle respective to a surface of a main supporting rail or beam.

9. The inspection system of claim 6, wherein a clip spring presence is identified utilizing a contrast ratio between the spring and its surroundings.

10. A method of inspecting tenter clips during a biaxially oriented polymer film manufacturing process comprising:
identifying a presence of a clip for inspection using an inductive proximity sensor;
inspecting the identified clip using a high-speed and high-resolution camera;
determining a pass/fail result for each tenter clip inspected by the camera using a processor; and
cooling the camera to maintain a temperature of camera at 54° C. or lower during operation.

11. The method claim 10, further comprising illuminating the clip as it is inspected by the camera using a strobe lighting system.

12. The method of claim 11, wherein the strobe lighting system comprises LED lighting.

13. The method of claim 10, wherein guide bearings of each tenter clip are inspected by the camera.

14. The method of claim 10, wherein the vertical bearings of each tenter clip are inspected by the camera.

15. The method of claim 10, wherein the springs of each tenter clip are inspected by the camera.

16. The method of claim 10, wherein the determining a pass/fail result for each tenter clip comprises determining whether guide bearings of each tenter clip is within a certain distance between a top of the bearing to a surface of a main supporting rail or beam.

17. The method of claim 10, wherein the determining a pass/fail result for each tenter clip comprises determining whether guide bearings of each tenter clip is within a certain angle respective to a surface of a main supporting rail or beam.

18. The method of claim 15, wherein a clip spring presence is identified utilizing a contrast ratio between the spring and its surroundings.
